(19) United States
(12) Patent Application Publication
(10) Pub. No.: US 2008/0219656 A1
(43) Pub. Date: Sep. 11, 2008

(54) Camera System With Auxiliary Viewfinder

(76) Inventors: David Staudacher, Fort Collins, CO (US); Jeffrey S. Tiffan, Greeley, CO (US); Eric F. Aas, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/683,406

(22) Filed: Mar. 7, 2007

(51) Int. Cl. G03B 13/02

(52) U.S. Cl. 396/373

(57) ABSTRACT

Camera systems and methods for implementing an auxiliary viewfinder are disclosed. An exemplary method may comprise providing a connection on a body of an electronic device for optionally attaching an auxiliary viewfinder. The method may also comprise positioning the auxiliary viewfinder when the auxiliary viewfinder is connected to the body of the electronic device so that a field-of-view for the auxiliary viewfinder is substantially the same as a field-of-view for an onboard lens.

### BACKGROUND

Digital cameras are widely commercially available, ranging both in price and in operation from sophisticated single lens reflex (SLR) cameras used by professional photographers to inexpensive “point-and-shoot” cameras that nearly anyone can use with relative ease. Initially, these cameras were typically provided with built-in optical viewfinders along with a digital display (e.g., a liquid crystal display or LCD). Accordingly, the camera user could use either the optical viewfinder on the LCD display to frame their picture.

In the past several years, digital cameras have been introduced without optical viewfinders, e.g., in order to help keep costs down and/or make cameras smaller. Some camera users have become accustomed to framing their pictures using the LCD display, and accordingly do not find this to be a drawback. However, many camera users still prefer to the optical viewfinder for one reason or another. For example, some camera users find it difficult to view the image on an LCD display in bright sunlight. Other camera users find it awkward to hold the camera at some distance in front of them so that they can see the LCD display while trying to take a picture.

### BRIEF DESCRIPTION OF THE DRAWINGS

FIG. 1 is a perspective view of an exemplary camera system as it may be implemented with an auxiliary viewfinder. FIG. 1a shows an exemplary micro-display.

FIG. 2 is a block diagram of exemplary operational components which may be implemented in a camera system for an auxiliary viewfinder.

FIGS. 3a and 3b illustrate alignment of an exemplary auxiliary viewfinder with the camera lens field-of-view.

FIGS. 4a and 4b illustrate alternative alignment of an exemplary auxiliary viewfinder with the camera lens field-of-view.

FIG. 5 is a flowchart illustrating exemplary operations to implement an auxiliary viewfinder for a camera system.

### DETAILED DESCRIPTION

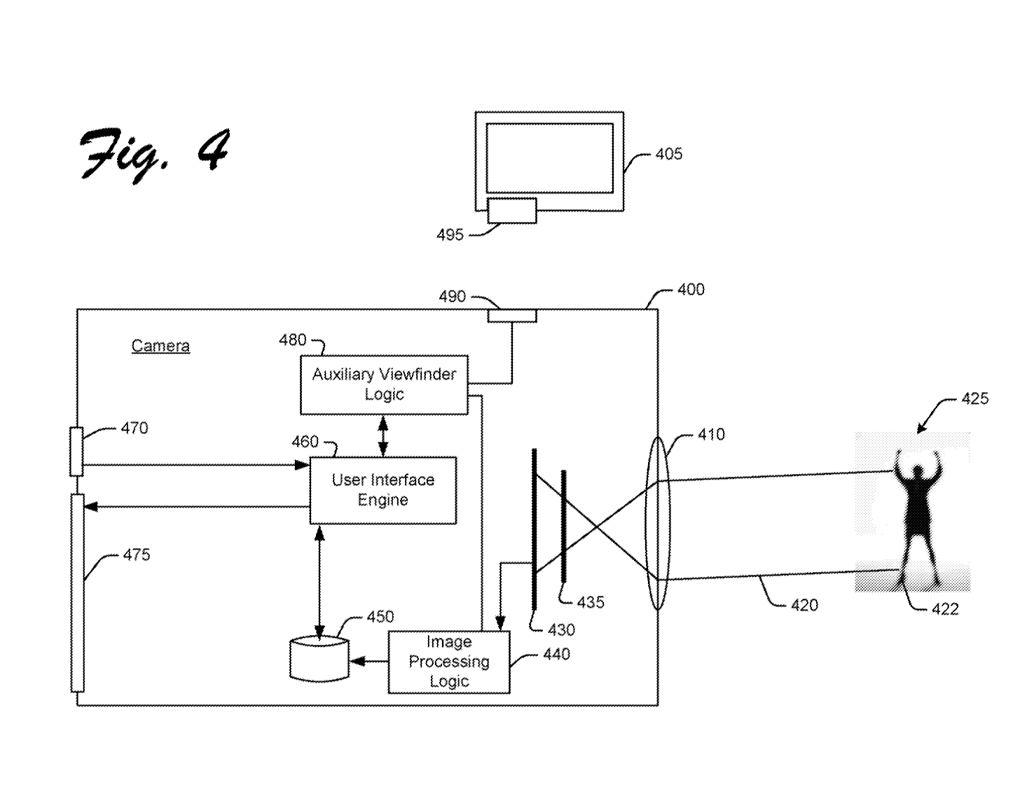

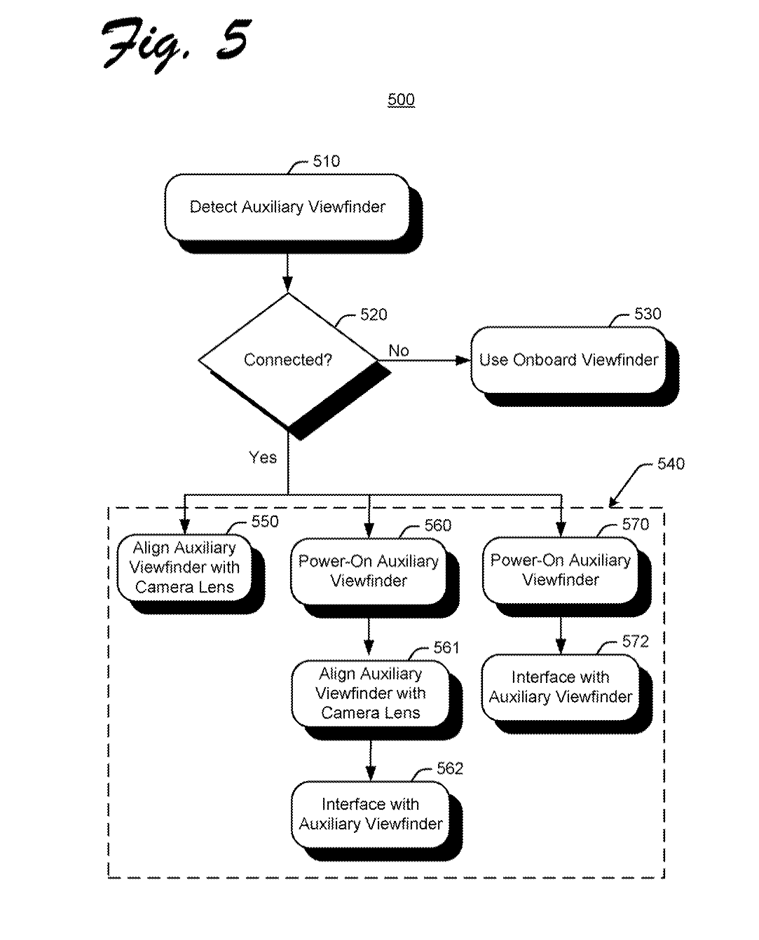

Systems and methods are disclosed for implementing one or more auxiliary viewfinder(s) on a camera. In exemplary embodiments, the auxiliary viewfinder may be an optical viewfinder that can be connected/disconnected from the camera system. In another embodiment, the auxiliary viewfinder may include a micro-display. Generally, when a micro-display is used, there are no optics in the viewfinder. Instead, the digital content (image and/or user interface) displayed on the camera's onboard display (475, FIG. 4) is scaled to the dimensions of the LCD in the viewfinder and continuously updated. Accordingly, the same camera system may be manufactured and shipped with or without the auxiliary viewfinder, and the consumer can determine whether to use (of separately purchase the viewfinder). Different users of the same camera may also have preferences as to whether to use the auxiliary viewfinder or the onboard viewfinder.

Although the systems and methods are described herein as they may be implemented on a digital camera, it is noted that the systems and methods may also be implemented on any of a wide variety of other imaging devices and even other types of electronic devices (e.g., mobile phones, media players, etc.).

### Exemplary Systems

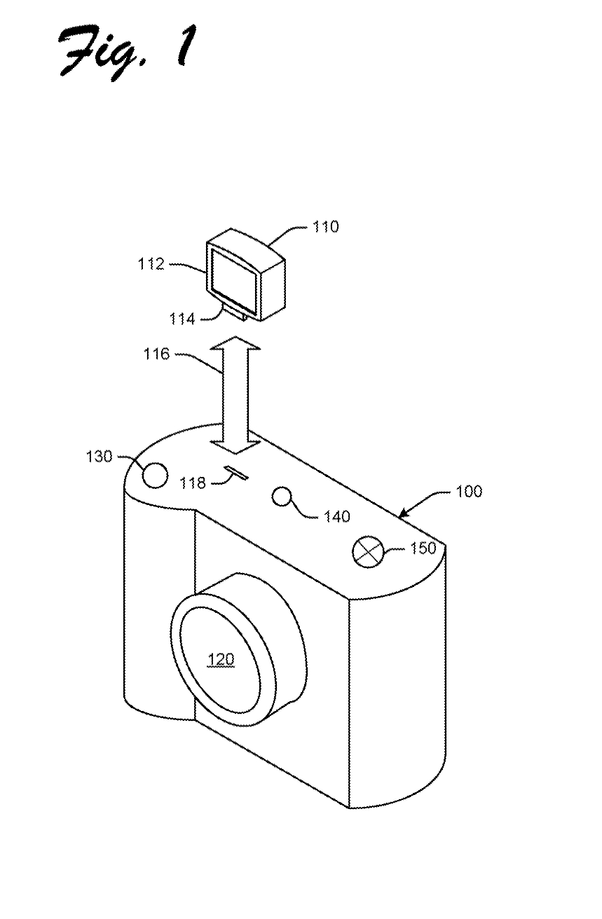

FIG. 1 is a perspective view of an exemplary camera system 100 as it may be implemented with an auxiliary viewfinder 110. In the embodiment shown in FIG. 1, the camera system 100 is a digital still camera. However, camera system 100 may be any suitable still or video camera.

The exemplary camera system 100 shown in FIG. 1 may include a lens 120, power button 130, image capture button 140, and settings knob 150. An LCD display or other display may be provided on the back side of the camera system 100 (and therefore is not visible in FIG. 1). In addition to showing the field-of-view for the camera lens 120, the LCD display may also implement a graphical user interface that the user may operate to change various camera settings. Other camera controls may include zoom buttons, rocker switches, etc. These and other camera controls are well known to those having ordinary skill in the camera arts and therefore, for purposes of brevity, these are not shown in the drawings or discussed further herein.

In an exemplary embodiment, the auxiliary viewfinder 110 may include a lens 112 for focusing on the field-of-view of the camera lens 120. Auxiliary viewfinder 110 may be attached to the camera by connecting faster 114 to mating connection 118 as illustrated by arrows 116. The fastener 114 may be used to mechanically attach the auxiliary viewfinder 110 to body of the camera system 100 so that it remains intact even when users pick up and operate the camera system 100.

If power and/or data transfer is to be provided between the camera system 100 and the auxiliary viewfinder 110, the fastener 114 may also include a data port and/or power connecting for the auxiliary viewfinder 110. It is noted, however, that substitutions may be made. For example, the auxiliary viewfinder 110 may be battery powered, and a wireless or other suitable data transfer mechanism may be used.

In use, the auxiliary viewfinder 110 may be an optical viewfinder that can be connected/disconnected from the camera system, as illustrated in FIG. 1. The optical viewfinder may include a lens similar to the on-board optical viewfinders provided on conventional cameras. It is noted, however, that the auxiliary viewfinder 110 is not limited to any particular configuration. In another embodiment, the auxiliary viewfinder 110 may include a micro-display. FIG. 1a shows an exemplary micro-display 160. The micro-display 160 is similar to the digital output on the camera's onboard display 180 (e.g., the LCD display) and shows the output 170 being displayed on the camera's onboard display (e.g., an electronic rendition of a subject in the scene being photographed or the user interface) in a scaled-down digital form 170′ in the micro-display. Still other embodiments are also contemplated, as will be readily apparent to those having ordinary skill in the art after becoming familiarly with the teachings herein.

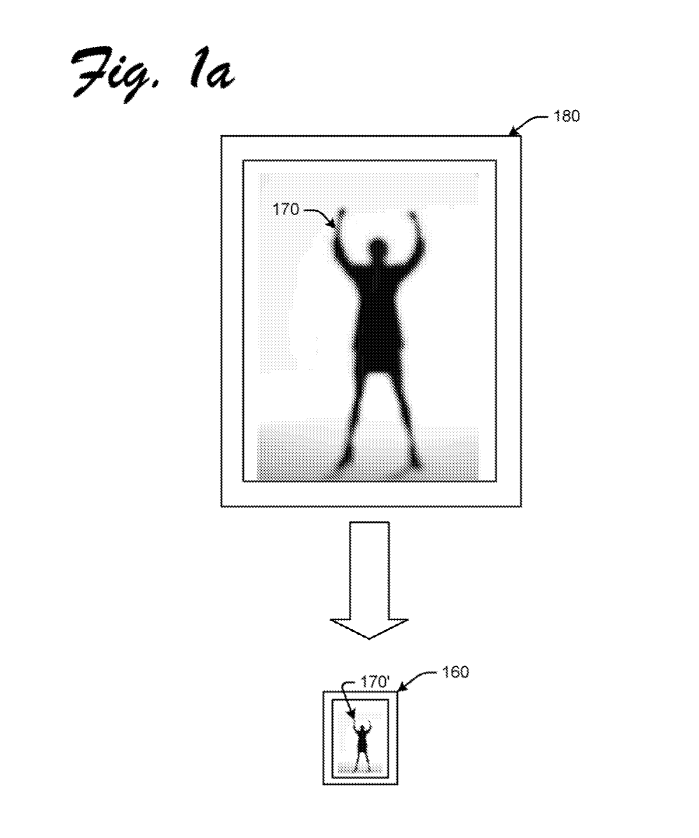

FIGS. 2a and 2b illustrate alignment of an exemplary auxiliary viewfinder 200 with the field-of-view of a camera lens 210. For purposes of illustration, a camera lens 210 is shown as it may be positioned in a camera system (e.g., the camera system 100 in FIG. 1) to focus light 220 reflected from one or more objects 222 in a scene 225 onto an image capture device or image sensor 230 when a shutter 235 is open (e.g., for image exposure).

Camera lens, shutters, and image sensors, such as those illustrated in FIGS. 2a and 2b, are well-understood in the camera and photography arts. These components may be readily provided by those having ordinary skill in the art after becoming familiar with the teachings herein and therefore further description is not necessary.

When auxiliary viewfinder 200 is positioned adjacent the camera lens 210, the field-of-view 240 of the auxiliary viewfinder 200 may not be the same as the field-of-view 250 of the camera lens 210, as illustrated in FIG. 2a. Accordingly, the auxiliary viewfinder 200 may be rotated (e.g., in the direction illustrated by arrow 260) so that the field-of-view 245 of the auxiliary viewfinder 200 is substantially the same as the field-of-view 245 of the camera lens 210, as illustrated in FIG. 2b. Accordingly, the image that the user views through the auxiliary viewfinder 200 is the same, or at least substantially the same as the image being captured by the image sensor 230.

Auxiliary viewfinder 200 (or a lens within the auxiliary viewfinder 200) may be rotated to achieve field-of-view alignment according to any of a wide variety of different mechanisms. Auxiliary viewfinder 200 may be rotated automatically by an electric motor of manually during an initial calibration (e.g., at the manufacturing facility), or each time the auxiliary viewfinder 200 is attached to the camera system. Program code may also be provided to assist with automatic alignment, wherein the program code registers an image on the image sensor and receives feedback from the auxiliary viewfinder 200. The program code may then adjust the position of the auxiliary viewfinder 200 until the two images are the same or at least substantially the same. Other embodiments are also contemplated.

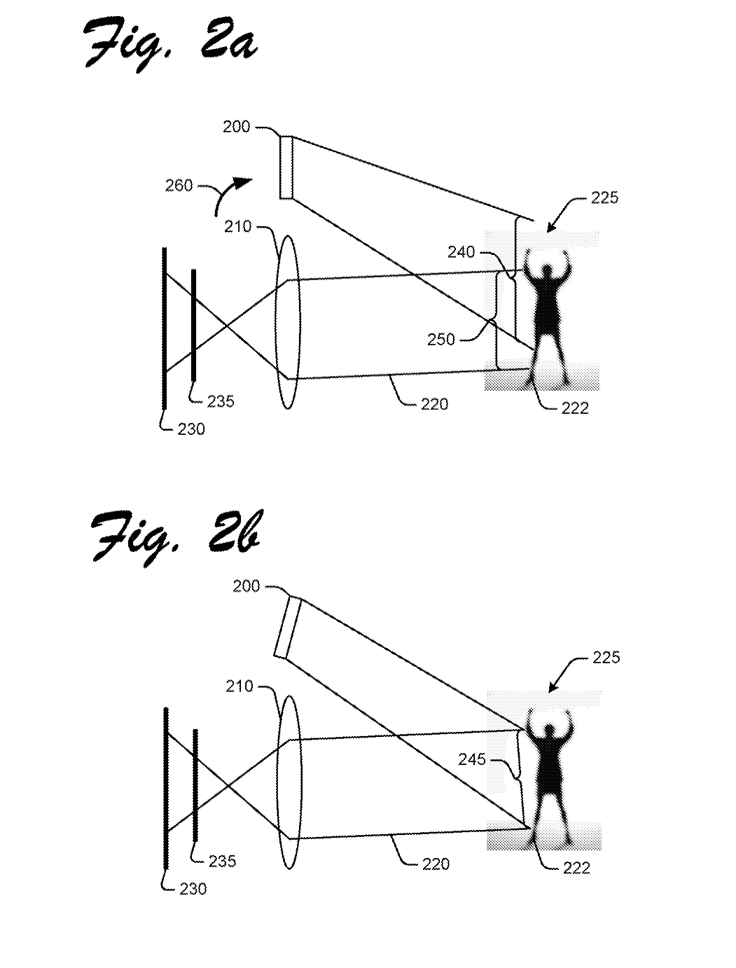

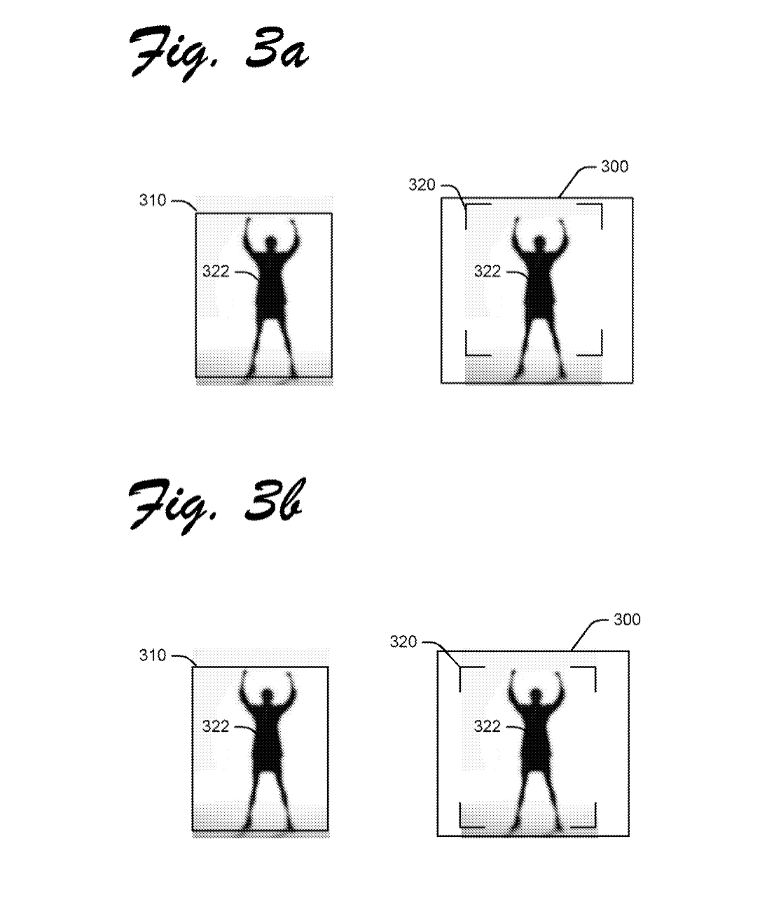

FIGS. 3a and 3b illustrate alternative alignment of an exemplary auxiliary viewfinder 300 with the camera lens field-of-view 310. In this example, the camera lens field-of-view 310 is illustrated on the left-hand side of FIGS. 3a and 3b, and the field-of-view of the auxiliary viewfinder 300 is illustrated by brackets 320 on the right-hand side of FIGS. 3a and 3b which may be displayed for the user for focusing the camera on the subject.

It is readily observed in FIG. 3a that the object 322 registered by the image sensor is not the same as the object framed by brackets 320 in the auxiliary viewfinder. In an exemplary embodiment, program code may be implemented to frame the object 322 in the auxiliary viewfinder 300 so that the field-of-view matches (or at least substantially matches) that of the camera lens. In FIG. 3b it is observed by moving the brackets 320 displayed for the user in the auxiliary viewfinder 300, the object 322 framed by brackets 320 is the same as the object 322 registered by the image sensor.

Accordingly, the field-of-view of the auxiliary viewfinder 300 can be adjusted without having to physically move the auxiliary viewfinder. Alternatively, the field-of-view may be aligned using a combination of physically moving the auxiliary viewfinder 300 and moving the brackets 320 displayed for the user in the auxiliary viewfinder.

FIG. 4 is a block diagram of exemplary operational components which may be implanted in a camera system 400 for an auxiliary viewfinder 405. As is well understood in the camera and photography arts, operational components for a camera typically include a camera lens 410 to focus light 420 reflected from one or more objects 422 in a scene 425 onto an image capture device or image sensor 430 when a shutter 435 is open (e.g., for image exposure). As is also well understood, operational components may also include image processing logic 440 to convert electrical signals from the image sensor 430 representative of the light 420 captured by the image sensor 430 during exposure to generate a digital image of the scene 425. The digital image may be stored in the camera's memory 450 (e.g., internal memory and/or a removal memory card).

Operational components may also include a user interface engine 460. The user interface engine 460 may be operatively associated with various input devices 470 (e.g., buttons, knobs, switches, etc., on the camera 400) and an onboard display 475 (e.g., the camera LCD display). User interface engine 460 may be implemented to display images for the user and/or receive input from the user (e.g., to adjust various camera settings, select pictures to display, etc.).

In an exemplary embodiment the camera system 400 may include a control interface may be a mechanical mechanism or an electronic mechanism for positioning the auxiliary viewfinder so that a field-of-view for the auxiliary viewfinder is substantially the same as a field-of-view for the onboard viewfinder. For example, the control interface may include auxiliary viewfinder logic 480 and a port 490. The auxiliary viewfinder logic 480 may be operatively associated with the port 490 (e.g., an electrical, mechanical, and/or data port that mates with port 495 on the auxiliary viewfinder 405). When the auxiliary viewfinder 405 is connected to the camera 400, an electrical signal or other trigger (e.g., magnetic, mechanical switch) is received via port 490 to activate the auxiliary viewfinder logic 480. In other embodiments the user may manually activate the auxiliary viewfinder logic 480, e.g., by using input devices 470 via user interface engine 460 when the auxiliary viewfinder 405 is connected to the camera 400.

In an exemplary embodiment, auxiliary viewfinder logic 480 is implemented in program code (e.g., firmware and/or software) residing in memory on the digital camera and executable by a processor in the digital camera, such as the memory and processor typically provided with commercially available digital cameras. The auxiliary viewfinder logic 480 may be operatively associated with the image processing logic 440, e.g., for aligning the field-of-view of the auxiliary viewfinder 405 with the field-of-view of the camera lens 210 as discussed above for FIGS. 2a-b and 3a-b. The auxiliary viewfinder logic 480 may also be operatively associated with the user interface engine 460 for displaying output on the auxiliary viewfinder, e.g., in a micro-display such as the micro-display shown in FIG. 1a.

It is noted that although the logic blocks are shown in FIG. 4 for purposes of illustration as being separate, these may all be embodied together in the firmware. It is also noted that the logic blocks may also be embodied in hardware and/or a combination of firmware (or other program code) and hardware.

Before continuing, it is also noted that the embodiments shown and described above are merely exemplary. The systems and methods described herein, however, are not intended to be limited to these embodiments. Other embodiments are also contemplated as will be readily appreciated by those having ordinary skill in the art after becoming familiar with the teachings herein.

### Exemplary Operations

Exemplary operations may be embodied as logic instructions on one or more computer-readable medium. When executed on a processor (e.g., in the camera), the logic instructions implement the described operations. In an exemplary embodiment, the components and connections depicted in the figures may be implemented.

FIG. 5 is a flowchart illustrating exemplary operations to implement an auxiliary viewfinder for a camera system. In operation 510, the auxiliary viewfinder is detected. For example, logic in the camera system may be used to “ping” the auxiliary viewfinder (e.g., by issuing an electrical signal and waiting for a return signal within a specified time period). Or for example, the auxiliary viewfinder may automatically issue an electrical signal to logic in the camera system when the auxiliary viewfinder is connected. In operation 520, a determination is made whether the auxiliary viewfinder is connected to the camera system. In other embodiments, a flag may be set to indicate whether the auxiliary viewfinder is connected to the camera system. For example, the flag may be set if the auxiliary viewfinder is connected to the camera system. Otherwise, the flag is not set by default.

If the auxiliary viewfinder is not connected to the camera system, the onboard viewfinder is used in operation 530. If the auxiliary viewfinder is connected to the camera system, a number of options are available, some of which are illustrated by block 540.

In operation 550, the auxiliary viewfinder may be aligned with the camera lens (e.g., where the auxiliary viewfinder is mechanical and does not need to be powered on). If the auxiliary viewfinder is electronic, the auxiliary viewfinder may be powered on in operation 560, aligned with the camera lens in operation 561, and interfaced in operation 562 (e.g., the auxiliary viewfinder may be controlled by logic in the camera system).

Alternatively, the auxiliary viewfinder may be aligned with the camera lens at an earlier time (e.g., during calibration), and therefore does not need to be repeated each time the auxiliary view finder is connected to the camera system. For example, the auxiliary viewfinder may be powered on in operation 570, and then interfaced in operations 572.

It is noted that the exemplary operations described with reference to FIG. 5 are merely exemplary and are not limiting. For example, the operations are not limited to the ordering shown in FIG. 5. Additional, fewer and/or different operations may also be implemented.

It is also noted that the exemplary embodiments shown and described are provided for purposes of illustration and are not intended to be limiting. Still other embodiments to implement an auxiliary viewfinder on a camera system are also contemplated.

1. A camera system comprising:
an onboard viewfinder provided in a body of the camera system;
an auxiliary viewfinder for optionally connecting and disconnecting to the body of the camera system; and
a control interface for positioning the auxiliary viewfinder so that a field-of-view for the auxiliary viewfinder is substantially the same as field-of-view for the onboard viewfinder.

2. The camera system of claim 1 wherein the auxiliary viewfinder is an optical viewfinder.

3. The camera system of claim 1 wherein the auxiliary viewfinder includes a micro-display.

4. The camera system of claim 3 wherein the micro-display is continuously updated.

5. The camera system of claim 3 wherein the micro-display outputs an electronic rendition of the same image viewed through an optical viewfinder.

6. The camera system of claim 3 wherein the micro-display outputs a graphical user interface.

7. The camera system of claim 1 wherein the control interface is a mechanical mechanism.

8. The camera system of claim 1 wherein the control interface is an electronic mechanism.

9. The camera system of claim 1 wherein the control interface is driven by program code.

10. A method comprising:
providing a connection on a body of an electronic device for optionally attaching an auxiliary viewfinder; and
positioning the auxiliary viewfinder when the auxiliary viewfinder is connected to the body of the electronic device so that a field-of-view for the auxiliary viewfinder is substantially the same as a field-of-view for an onboard lens.

11. The method of claim 10 further comprising physically connecting the auxiliary viewfinder to the body of an electronic device.

12. The method of claim 10 further comprising electrically connecting the auxiliary viewfinder to the body of an electronic device.

13. The method of claim 10 further comprising outputting a micro-display within the auxiliary viewfinder.

14. The method of claim 10 further comprising outputting a graphical user interface within the auxiliary viewfinder.

15. The method of claim 10 further comprising outputting an electronic rendition of an image in the field-of-view of an optical viewfinder.

16. The method of claim 10 further comprising mechanically aligning the auxiliary viewfinder with the onboard lens.

17. The method of claim 10 further comprising electronically aligning the auxiliary viewfinder with the onboard lens.

18. The method of claim 10 further comprising determining in program code a substantial alignment of the auxiliary viewfinder with the onboard lens.

19. A system comprising:
means for optionally connecting an auxiliary viewfinder to a camera; and
means for substantially aligning a field-of-view of the auxiliary viewfinder with a field-of-view for an onboard camera lens.

20. The system of claim 19 further comprising means for scaling output from an onboard display and outputting the scaled output as a micro-display.
